(19) United States
(12) Patent Application Publication
(10) Pub. No.: US 2026/0365144 A1
(43) Pub. Date: Nov. 19, 2026

(54) PEDAL DEVICE

(71) Applicant: BOGE ELASTMETALL GMBH, Damme (DE)

(72) Inventors: Slawomir Bakaus, Bad Honnef (DE); Alexander HESSLING, Ruppichteroth (DE)

(21) Appl. No.: 19/124,127

(22) PCT Filed: Oct. 7, 2023
(86) PCT No.: PCT/EP2023/077809

§ 371 Date: Apr. 24, 2025

(30) Foreign Application Priority Data
Oct. 27, 2022 (DE) 10 2022 128 592.8

(51) Int. Cl. B60T 7/04; F16F 1/02; F16F 1/32; F16F 3/02; G05G 1/38; G05G 1/42; G05G 5/05

(52) U.S. Cl. CPC B60T 7/04; F16F 1/025; F16F 1/324; F16F 3/02; G05G 1/38; G05G 1/42; G05G 5/05; B60T 2220/04

(57) ABSTRACT

Pedal device with a housing (2), a bearing element (3), a pedal (4) displaceably guided on the bearing element (3) in an axial direction (x), a first spring means (5) which is connected to the bearing element (3) and to the pedal (4) and against the spring force of which the pedal is movable in the axial direction (x) relative to the bearing element (3), a first position detection device (6), by means of which a current axial position of the pedal (4) can be detected and at least one first position signal (S1) characterising this position can be provided, a second spring means (13) which is connected to the housing (2) and to the bearing element (3) and against the spring force of which the bearing element (3) is movable in the axial direction (x) relative to the housing (2), and a second position detection device (14) by means of which a current axial position of the bearing element (3) can be detected and at least one second position signal (S2) characterising this position can be provided.

The invention relates to a pedal device with a housing, a bearing element, a pedal displaceably guided on the bearing element in an axial direction, a first spring means which is connected to the bearing element and to the pedal and against the spring force of which the pedal is movable in the axial direction relative to the bearing element, and a first position detection device by means of which a current axial position of the pedal, in particular relative to the housing, can be detected and at least one first position signal characterising this position can be provided.

DE 198 36 691 A1 discloses a pedal device for electrically actuatable motor vehicle brakes, with a pedal body which is movable in the actuation direction in a translatory manner and which is under the force effect of a spring counteracting the actuation direction as a return means, which preferably has a linear characteristic curve. The pedal body has a contact means which converts at least one linearly increasing actuation travel increment into progressively increasing spring travel increments and impresses it on the adjacent spring, with a cam having a defined, non-linear cam contour being provided as a contact means. At the foot end, the pedal body comprises a thickened cap to which adjoins a shaft, which is loaded at its end by a return spring.

The disadvantage of this solution is that jamming of the pedal or a defect in the suspension of the pedal, such as a spring break, cannot be identified automatically.

Proceeding from this, the object underlying the invention is in particular to create a pedal device by means of which an automatic identification of a defect in the suspension and/or a jamming of the pedal is possible.

According to the invention, this object is achieved with a pedal device according to claim 1. Preferred further developments of the invention are given in the subclaims and in the following description.

A pedal device with a housing, a bearing element, a pedal displaceably guided on the bearing element in an axial direction, a first spring means which is connected to the bearing element and to the pedal and against the spring force of which the pedal is movable in the axial direction relative to the bearing element, and a first position detection device by means of which a current axial position of the pedal, in particular relative to the housing, can be detected and at least one first position signal characterising this position can be provided, is in particular further formed according to the invention by a second spring means which is connected to the housing and to the bearing element and against the spring force of which the bearing element is movable in the axial direction relative to the housing, and a second position detection device, by means of which a current axial position of the bearing element, in particular relative to the housing, can be detected and at least one second position signal characterising this position can be provided.

If there is a defect in the suspension of the pedal or if it is jammed, the position detection devices can be used to detect axial positions of the pedal and bearing element that do not occur simultaneously when the pedal device is intact. As a result, a defect in the suspension and/or jamming of the pedal can be identified by evaluating the position signals.

A, preferably axial, position of the pedal that is set when the pedal device is not actuated is in particular referred to as the pedal rest position. A, preferably axial, position of the bearing element that is set when the pedal device is not actuated is in particular referred to as the bearing element rest position.

Preferably, the two spring means, in particular by interconnection of the bearing element, are connected in series. The pedal is preferably connected, in particular resiliently, to the housing via the or a series connection of the two spring means. Advantageously, the pedal is movable against the spring force of the or a series connection of the two spring means, in particular starting from the or a pedal rest position, in the axial direction relative to the housing. The bearing element is in particular movable against the spring force of the second spring means starting from the or a bearing element rest position in the axial direction relative to the housing. The pedal is, for example, movable against the spring force of the first spring means starting from a relative rest position in the axial direction relative to the bearing element. The first spring means is preferably elastically deformable in the axial direction, in particular by way of an axial actuation of the pedal. The second spring means is preferably elastically deformable in the axial direction, in particular by way of an axial actuation of the pedal and/or the bearing element.

The current axial position of the pedal relative to the housing can preferably be detected by means of the first position detection device. The first position signal characterises in particular this position of the pedal and/or a current axial stroke of the pedal with respect to the or a pedal rest position. Advantageously, the first position signal is an electrical signal. The current axial position of the bearing element relative to the housing can preferably be detected by means of the second position detection device. The second position signal characterises in particular this position of the bearing element and/or a current axial stroke of the bearing element with respect to the or a bearing element rest position. Advantageously, the second position signal is an electrical signal.

A longitudinal axis running in the axial direction is preferably assigned to the pedal device. The longitudinal axis in particular runs centrally through the pedal and/or centrally through the bearing element and/or centrally through each spring means and/or centrally through the housing. An axial actuation force lying on the longitudinal axis and acting on the pedal preferably does not lead to any torque acting on the pedal and/or on the bearing element, in particular with respect to the housing. Advantageously, the pedal is displaceable relative to the bearing element in the axial direction. A or any direction running transversely to the axial direction and/or transversely to the longitudinal axis is in particular referred to as the radial direction. A direction running around the longitudinal axis is preferably referred to as the circumferential direction.

According to one configuration, the pedal has an, in particular end-side, actuation section preferably arranged outside the bearing element and a, preferably rod-shaped, guide section extending, in particular in the axial direction, away therefrom. In the bearing element is preferably provided an axial guide hole into which the guide section extends and/or through which the guide section extends. The pedal is preferably guided in particular so as to be displaceable on the bearing element in the axial direction. Advantageously, the guide section runs in an axial direction, preferably straight. The longitudinal axis in particular runs centrally through the guide section and/or centrally through the guide hole. The actuation section consists, for example, of plastic and/or metal. The actuation section in particular forms a rigid body. The guide section consists, for example, of plastic and/or metal. The guide section in particular forms a rigid body. For example, the guide section is designed to be cylindrical, in particular at least in regions, and/or the guide section has, for example, a cylindrical outer circumferential surface. Advantageously, the actuation section is rigidly connected to the guide section. The actuation section is in particular arranged outside the housing.

The actuation section, in particular at least in regions, preferably has larger dimensions transversely to the axial direction than the guide section and/or than the guide hole and/or than the bearing element. The actuation section, in particular at least in regions, is preferably plate-shaped. For example, the actuation section is or comprises a pedal plate. Advantageously, the actuation section and/or the pedal plate is provided at a preferably free end of the pedal, in particular facing away from the housing and/or the bearing element. A pedal cap, preferably consisting of an elastomer, is in particular seated on the actuation section and/or the pedal plate. The pedal cap advantageously covers a side or end face of the actuation section and/or the pedal plate facing away from the housing and/or the bearing element and/or the guide section. The pedal consists, for example, of plastic and/or metal. The pedal in particular forms a rigid body.

The guide hole is preferably a continuous hole. The guide section in particular extends through the guide hole or the continuous hole. The guide section preferably protrudes on a side of the bearing element facing away from the actuation section from the guide hole with an end region. Advantageously, the end region of the guide section comprises or forms a securing means by means of which the pedal and/or the guide section is axially supported and/or can be supported on the bearing element. The securing means, in particular at least in regions, preferably has larger dimensions than the guide hole transversely to the axial direction. For example, the securing means forms or comprises at least one stop, preferably protruding transversely to the axial direction. For example, the securing means determines or influences the or a relative rest position of the pedal with respect to the bearing element and/or the or a pedal rest position. The bearing element consists, for example, of plastic and/or metal. The bearing element in particular forms a rigid body. The bearing element preferably extends or runs in an axial direction, preferably straight. For example, the bearing element, in particular at least in regions, is designed to be cylindrical or hollow-cylindrical and/or the bearing element has, for example, a cylindrical outer circumferential surface.

The first spring means is preferably arranged between the pedal and the bearing element. The first spring means is in particular arranged, preferably in an axial direction, between the actuation section and the bearing element. The first spring means is preferably supported axially both on the bearing element and on the pedal. The first spring means is in particular supported axially both on the bearing element and the actuation section. Advantageously, the pedal and/or the guide section extends through the first spring means. The first spring means preferably is or comprises one or at least one compression spring. For example, the first spring means is or comprises one or at least one coil spring. The pedal and/or the actuation section is preferably resiliently supported on the bearing element by means of the first spring means, in particular in the axial direction.

According to a further development, at least one of the spring means is preloaded in the axial direction. The first spring means is preferably preloaded in the axial direction. Thus, it is possible, for example, by actuating the pedal, to move the bearing element, in particular over an axial travel distance, together with the pedal, which is only moved relative to the bearing element, for example, when the preloading is exceeded. Alternatively, for example, the second spring means is preloaded in the axial direction.

The second spring means is preferably arranged in the housing. The bearing element is preferably movably guided by the second spring means in an axial direction, in particular on or in the housing.

For example, the movability of the bearing element, in particular by way of the second spring means, is limited to only one dimension, preferably relative to the housing. This dimension is given in particular by the axial direction. For example, the mobility of the pedal, in particular by way of the bearing element and/or by way of the second spring means, is limited to only one dimension, preferably relative to the housing and/or to the bearing element. This dimension is given in particular by the axial direction.

According to one configuration, the second spring means comprises one or a plurality of, in particular planar, flat springs which are aligned transversely to the axial direction, penetrated by the bearing element and resiliently supporting the bearing element on the housing, in particular in the axial direction. The number of flat springs is preferably two or at least two. Each flat spring is in particular planar. The flat springs are preferably of identical design. Advantageously, each flat spring lies or runs, in particular in the non-tensioned state, in a flat spring plane that preferably runs transversely to the axial direction. The flat springs can be used, for example, to implement small spring-loaded axial movement paths of the bearing element relative to the housing. For example, the, in particular maximum and/or free, spring travel of the second spring means and/or the flat springs is 3 mm, 5 mm or 3 mm to 5 mm. Each flat spring preferably consists of metal, in particular spring steel. Alternatively, each flat spring consists of plastic, for example. Each flat spring preferably has a central through-hole through which in particular the bearing element extends. Advantageously, each flat spring is penetrated by the bearing element by it extending through its central through-hole. For example, each flat spring forms a spring washer. The bearing element is preferably resiliently supported on the housing by means of the second spring means and/or by means of the flat springs, in particular in the axial direction.

The flat springs are preferably connected in parallel. The bearing element is preferably connected to the housing, in particular resiliently, via the or a parallel connection of the flat springs. Advantageously, the bearing element is movable against the spring force of the or a parallel connection of the flat springs, in particular starting from the or a bearing element rest position, in the axial direction relative to the housing.

The flat springs are preferably arranged one behind the other in the axial direction and at a distance from one another. Thus, axial guidance of the bearing element can in particular be implemented by way of the second spring means. Each flat spring preferably has a plurality of, in particular three or at least three, spring webs which are spaced apart and/or separated from each other preferably in the circumferential direction, in particular at least in regions, and which are arranged, preferably evenly distributed, in particular around the bearing element. Advantageously, the spring webs of each flat spring extend or run, in particular transversely to the axial direction, between the bearing element and the housing and/or from the bearing element to the housing. The spring webs are also referred to as spring leaves, for example. The spring webs of each flat spring in particular extend or run in their or the respective flat spring plane. The bearing element is preferably resiliently supported on the housing by means of or by interconnection of the spring webs, preferably at a, in particular radial, distance from the bearing element, in particular in the axial direction. As a result, the bearing element is, for example, resiliently supported on the housing, in particular by means of the second spring means and/or by means of the flat springs, preferably in the axial direction.

Each spring web preferably has an outer and/or free spring web end which in particular faces away from the bearing element and/or faces the housing and which is in particular a radially outer spring web end. For example, each flat spring is fastened to or in the housing with its outer and/or free spring web ends. Each spring web preferably has an inner spring web end which in particular faces the bearing element and/or faces away from the housing and which is in particular a radially inner spring web end. For example, each flat spring is fastened to the bearing element with its inner spring web ends.

Each flat spring preferably has an outer frame which, in particular is firmly connected with its spring webs and/or with its outer and/or free spring web ends. The spring webs of each flat spring preferably extend from their outer frame in the direction of the bearing element. The outer frame of each flat spring is in particular ring-shaped or a ring and is also referred to as an outer ring, for example. Each flat spring, in particular on its outer circumference and/or with its outer frame, is preferably fastened to the housing. Advantageously, each flat spring, in particular on its outer circumference and/or with its outer frame, engages in one or at least one groove which is provided on the inner circumference of the housing and which is preferably a ring groove. Each flat spring and/or the outer frame of each flat spring preferably has a round and/or circular outer circumferential contour.

Each flat spring preferably has an inner frame, in particular firmly connected with its spring webs and/or with its inner spring web ends. The inner frame of each flat spring in particular delimits its central through-hole. Advantageously, the inner frame surrounds or encircles the bearing element. The bearing element extends in particular through the inner frame. For example, the inner frame of each flat spring is penetrated by the bearing element. The spring webs of each flat spring preferably extend from their inner frame in the direction of the housing and/or in the direction of the respective outer frame. Advantageously, the spring webs are arranged, preferably evenly distributed, around the inner frame. The inner frame of each flat spring is in particular ring-shaped or a ring and is also referred to as an inner ring, for example. Advantageously, each flat spring is firmly seated with its inner frame on the bearing element, in particular penetrating it. Each flat spring, in particular on its inner circumference and/or with its inner frame, is preferably fastened to the bearing element. Advantageously, each flat spring, in particular on its inner circumference and/or with its inner frame, engages in one or at least one groove which is provided on the outer circumference of the bearing element and which is preferably a ring groove. Each flat spring and/or the inner frame of each flat spring preferably has a round and/or circular inner circumferential contour.

The outer frame of each flat spring preferably surrounds or encircles its inner frame, advantageously at a, in particular radial, distance. The spring webs of each flat spring preferably extend from their inner frame to their outer frame.

Each spring web or each spring web of each flat spring, in particular within its flat spring plane, preferably is or runs for example, angled and/or bent and/or curved once or repeatedly. Each spring web or each spring web of each flat spring, in particular within its flat spring plane, preferably is or runs bent back and forth and/or in an S-shape. A linear behaviour and/or a linear characteristic can in particular be achieved with spring webs shaped in this way. Alternatively, for example, each spring web or each spring web of each flat spring, in particular within its flat spring plane, runs straight, preferably transversely to the axial direction. For example, such straight spring webs can be used to achieve a progressive behaviour and/or a progressive characteristic curve.

The housing is preferably designed to be cylindrical, in particular at least in regions. For example, the housing is pot-shaped. The housing consists, for example, of plastic and/or metal. For example, the housing comprises a, preferably cylindrical, metal sleeve in which, for example, the flat springs are seated and/or to which, for example, the flat springs are fastened. The metal sleeve in particular ensures that the flat springs are permanently firmly seated. The metal sleeve preferably encircles the flat springs. The metal sleeve consists, for example, of steel or aluminium. Each flat spring is preferably fastened to the metal sleeve at its outer circumference and/or with its outer frame. Each flat spring in particular engages on its outer circumference and/or with its outer frame in one or at least one groove which is provided on the inner circumference of the metal sleeve and which is preferably a ring groove. The groove or grooves provided on the inner circumference of the metal sleeve are in particular the groove or grooves provided on the inner circumference of the housing. Advantageously, the housing, in particular in addition to the metal sleeve, comprises at least one housing region of plastic, with the housing region of plastic preferably being firmly connected to the metal sleeve. The housing region of plastic preferably comprises a plurality of housing parts which are firmly connected to one another, for example by way of fastening means. The housing in particular forms a rigid body.

The position detection devices, which are for example also referred to as position sensors, preferably comprise sensors, such as Hall sensors and/or inductive sensors. The sensors are preferably provided on the housing and/or are stationary relative thereto. For example, the first position detection device comprises at least one magnet fastened to the pedal and/or the guide section and at least one Hall sensor fastened to the housing. Furthermore, the second position detection device comprises, for example, at least one magnet fastened to the bearing element and at least one Hall sensor fastened to the housing.

According to a further development, an evaluation device is provided which is preferably connected to the position detection devices and by means of which the position signals can in particular be evaluated.

The position signals can preferably be evaluated by means of the evaluation device in that, in particular, current values of the position signals are or can be compared with predefined position signal values. The predefined position signal values can be calculated and/or determined by tests, for example. The predefined position signal values preferably correspond to values of position signals provided by the position detection devices with the intact pedal device, i.e. in particular with intact suspension and without jamming of the pedal.

The evaluation device comprises, for example, an analogue computer or a digital computer. At least one result signal characterising the or a result of the evaluation and/or the or a result of the comparison can preferably be provided by means of the evaluation device. Advantageously, the result signal is an electrical signal.

The first and/or the second position detection device, for example by interconnection of the evaluation device, is or are preferably connected, in particular at least indirectly, to a control device by means of which at least one, preferably actuatable and/or controllable, vehicle component can be controlled depending on the first and/or the second position signal. However, the control device can also be integrated in the evaluation device or replace it. The vehicle component is or comprises, for example, a vehicle brake. The pedal is in particular a brake pedal. The pedal device is preferably provided for a vehicle which is in particular a motor vehicle.

The invention offers in particular the following advantages:
identifying a change in spring stiffness in one of the spring means, in particular in the event of a spring break.
identifying the jamming of one of the moving parts: pedal and bearing element.
reducing the probability of a single fault leading to the jamming of the two moving parts (pedal and bearing element) simultaneously.

The invention will be described below on the basis of a preferred embodiment with reference to the drawing. The drawing shows:

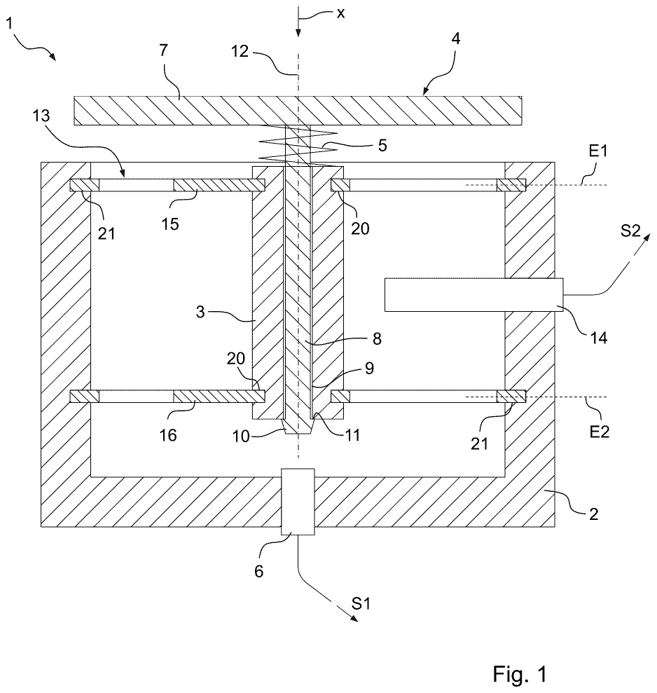

FIG. 1 a schematic sectional view of a pedal device according to one embodiment,

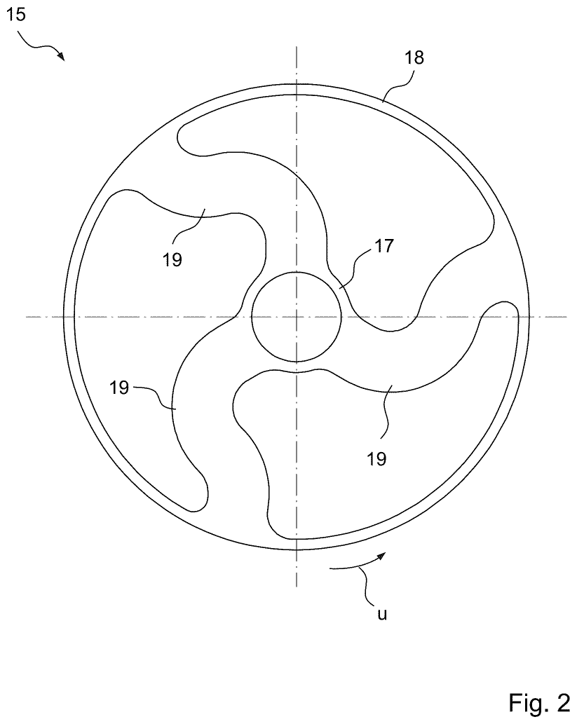

FIG. 2 a top view of one of the flat springs visible from FIG. 1,

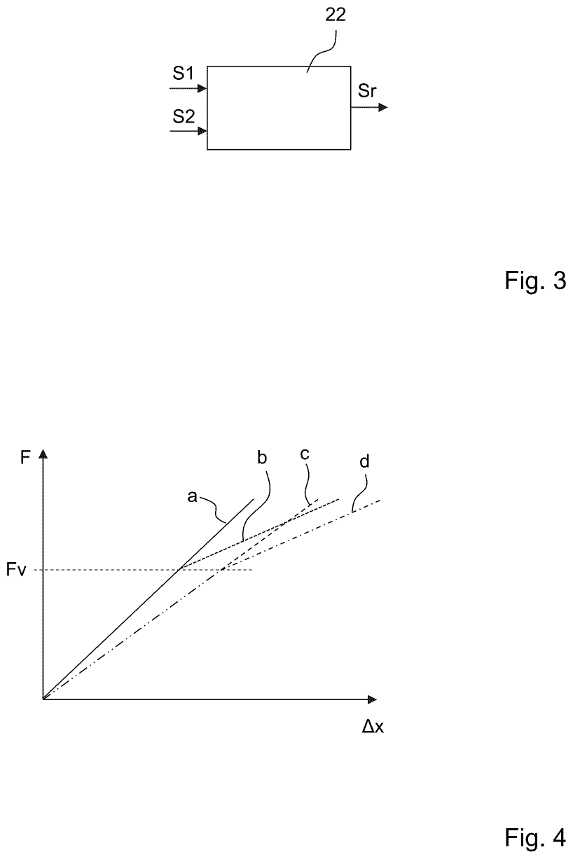

FIG. 3 a schematic view of an evaluation device and

FIG. 4 a schematic view of a plurality of measurement curves.

FIG. 1 shows a schematic sectional view of a pedal device 1 according to one embodiment, which comprises a housing 2, a bearing element 3, a pedal 4 displaceably guided on the bearing element 3 in an axial direction x, a first spring means 5 which is connected to the bearing element 3 and to the pedal 4 and against the spring force of which the pedal 4 is movable in the axial direction x relative to the bearing element 3, and a first position detection device 6, by means of which a current axial position of the pedal 4 relative to the housing 2 can be detected and at least one first position signal S1 characterising this position can be provided. The first spring means 5 is in particular axially preloaded and formed, for example, by a coil spring.

The pedal 4 has a, in particular plate-shaped, actuation section 7 arranged outside the bearing element 3, and a, in particular rod-shaped, guide section 8 which extends in the axial direction x away therefrom and which extends through an axial guide hole 9 provided in the bearing element 3. In this case, the guide section 8 protrudes from the guide hole 9 on a side of the bearing element 3 facing away from the actuation section 7 with an end region 10 which has a stop 11 which protrudes transversely to the axial direction x and by means of which the guide section 8 can be supported axially on the bearing element 3. The stop 11 thus forms a securing means. Furthermore, a longitudinal axis 12 extending in the axial direction x, in particular running centrally through the guide section 8, is assigned to the pedal device 1. A direction running transversely to the longitudinal axis 12 is in particular referred to as a radial direction. Furthermore, a direction running around the longitudinal axis 12 is in particular referred to as the circumferential direction u.

The pedal device 1 further comprises a second spring means 13 which is connected to the housing 2 and to the bearing element 3 and against the spring force of which the bearing element 3 is movable in the axial direction x relative to the housing 2, and a second position detection device 14, by means of which a current axial position of the bearing element 3 relative to the housing 2 can be detected and at least one second position signal S2 characterising this position can be provided.

The second spring means 13 comprises a plurality of, in particular two, planar flat springs 15 and 16 which are aligned transversely to the axial direction x, penetrated by the bearing element 3 and resiliently supporting the bearing element in an axial direction on the housing 2, and which are arranged one after the other in the axial direction x and at a distance from each other. The flat springs 15 and 16 are preferably identical in structure and run in each case in a flat spring plane, with the flat spring plane of the flat spring 15 being designated E1 and the flat spring plane of the flat spring 16 being designated E2. Each flat spring plane runs in particular transversely to the axial direction x.

A first of the flat springs 15 is shown in top view from FIG. 2 and has an inner ring 17, an outer ring 18 surrounding the inner ring and a plurality of, in particular three, spring webs 19 which are arranged around the inner ring 17 and which extend from the inner ring 17 to the outer ring 18 and are firmly connected both to the inner ring 17 and to the outer ring 18. In this case, the spring webs 19 are arranged evenly distributed around the inner ring 17 and are in particular S-shaped in each case. The flat spring 16 is designed accordingly.

Each flat spring is firmly seated with its inner ring 17 on the bearing element 3 and, for this purpose, preferably engages with its inner ring 17 in a ring groove 20 provided on the outer circumference of the bearing element 3. Furthermore, each flat spring is fastened to the housing 2 with its outer ring 18 and, for this purpose, preferably engages with its outer ring 18 in a ring groove 21 provided on the inner circumference of the housing 2.

FIG. 3 shows in a schematic view an evaluation device 22 which is connected to the position detection devices 6 and 14 and by means of which the position signals S1 and S2 can be evaluated, for example by comparing values of the position signals S1 and S2 with predefined position signal values. A result signal Sr characterising the result of the comparison is in particular provided by the evaluation device 22.

FIG. 4 shows measurement curves that were determined with intact and defective suspension. For this purpose, a force F acting in the axial direction x is applied to the pedal 4, while the stroke Δx covered by the pedal 4 and the bearing element 3 due to the force application is measured by means of the position detection devices 6 and 14. For example, during the measurement, the force, in particular starting from zero, is increased in a plurality of steps or continuously up to a maximum value. At a force of zero, the pedal is preferably located in a pedal rest position and the bearing element in a bearing element rest position. The first spring means 5 is in particular axially preloaded.

The course a of the bearing element and the course b of the pedal with intact pedal device 1 can be seen, with these courses a and b coinciding below the force Fv, which is attributable to the preloading of the first spring means 5. If, on the other hand, one of the flat springs 15 or 16 is broken, the course c results for the bearing element and the course d for the pedal.

Positions or travels are measured by means of the position detection devices 6 and 14 such that the detection of a spring break can take place e.g. via a changed travel characteristic. For this purpose, the series connection of the spring means 5 and 13 with respect to the housing 2 is used. The bearing element 3 and the pedal 4 have an expected stroke Ax corresponding to the curves a and b when force is applied. The representation illustrates the case with a preloaded first spring means 5 such that both position detection devices 6 and 14 output the same position signals until the preloading force Fv is reached. As soon as the preloading force Fv of the first spring means 5 is exceeded, the position detection devices 6 and 14 output different position signals. This separation of the position signals forms a characteristic point that always occurs at the same stroke Ax with intact spring means. If, on the other hand, one of the flat springs 15, 16 has a break, the characteristic point of signal separation is shifted towards a larger stroke Δx, which can be seen in the curves c and d. When evaluating the position signals, the shifting of the characteristic point can now be compared with the position of the characteristic point during calibration, which preferably takes place in advance with intact spring means. The characteristic point for calibration is thus in particular predefined.

### LIST OF REFERENCE NUMERALS

1 Pedal device
2 Housing
3 Bearing element
4 Pedal
5 First spring means
6 First position detection device
7 Actuation section
8 Guide section
9 Guide hole
10 End region
11 Stop/securing means
12 Longitudinal axis
13 Second spring means
14 Second position detection device
15 Flat spring
17 Inner ring
18 Outer ring
19 Spring web
20 Ring groove
21 Ring groove
22 Evaluation device
E1 Flat spring plane
E2 Flat spring plane
S1 First position signal
S2 Second position signal
Sr Result signal
u Circumferential direction×Axial direction

1. A pedal device comprising a housing, a bearing element, a pedal displaceably guided on the bearing element in an axial direction, a first spring means connected to the bearing element and to the pedal and against the spring force of which the pedal is movable in the axial direction relative to the bearing element, and a first position detection device, by means of which a current axial position of the pedal can be detected and at least one first position signal identifying this position can be provided, a second spring means connected to the housing and to the bearing element and against the spring force of which the bearing element is movable in the axial direction relative to the housing, and a second position detection device by means of which a current axial position of the bearing element can be detected and at least one second position signal identifying this position can be provided.

2. The pedal device according to claim 1, wherein the pedal has an actuation section arranged outside the bearing element and a guide section which extends in the axial direction away therefrom and which extends into an axial guide hole provided in the bearing element.

3. The pedal device according to claim 2, wherein the guide hole is a continuous hole through which the guide section extends, which protrudes on a side of the bearing element facing away from the actuation section from the guide hole with an end region, which has a securing means by means of which the guide section can be supported axially on the bearing element.

4. The pedal device according to claim 2, wherein the first spring means is arranged between the actuation section and the bearing element and is axially supported both on the pedal and on the bearing element.

5. The pedal device according to claim 1, wherein the first spring means is preloaded in the axial direction.

6. The pedal device according to claim 1, wherein the second spring means has one or a plurality of flat springs which are aligned transversely to the axial direction, penetrated by the bearing element and resiliently supporting the bearing element in the axial direction on the housing.

7. The pedal device according to claim 6, wherein the flat springs are arranged in the axial direction one behind the other and at a distance from each other.

8. The pedal device according to claim 6, wherein each flat spring has an inner ring, and an outer ring surrounding it, and a plurality of spring webs which are arranged around the inner ring and which extend from the inner ring to the outer ring.

9. The pedal device according to claim 8, wherein each flat spring is firmly seated with its inner ring on the bearing element and is fastened to the housing with its outer ring.

10. The pedal device according to claim 8, wherein each spring web has an S-shape.

11. The pedal device according to any claim 1, which comprises an evaluation device which is connected to the position detection devices by means of which the position signals can be evaluated, and at least one result signal identifying the result of the evaluation can be provided.
